(19) United States
(12) Patent Application Publication
(10) Pub. No.: US 2020/0090088 A1
(43) Pub. Date: Mar. 19, 2020

(54) ENTERPRISE HEALTH CONTROL PROCESSOR ENGINE

(71) Applicant: INTERNATIONAL BUSINESS MACHINES CORPORATION, Armonk, NY (US)

(72) Inventors: Pritpal Arora, Bangalore (IN); Klaus Koenig, Essenheim (DE); Jonathan R. Young, Guildford (GB)

(21) Appl. No.: 16/131,132

(22) Filed: Sep. 14, 2018

(51) Int. Cl. G06Q 10/06

(52) U.S. Cl. CPC G06Q 10/0635; G06Q 10/0637; G06Q 10/06393

(57) ABSTRACT

A system for measuring performance of an enterprise architecture includes an enterprise collaborative recommender engine that provides recommendations for an account within the enterprise architecture based upon enterprise assessments; a health control process engine that triggers rebuilding of the heat map topology view that provides recommendations for updating the enterprise architecture towards increased maturity in response to recommendations from the enterprise collaborative recommender engine; and an enterprise heat map generator that presents a heat map providing maturity information of the enterprise architecture for each domain.

### BACKGROUND

### Technical Field

The present disclosure generally relates to enterprise architecture frameworks, and more particularly to determining maturity levels in architecture frameworks.

### Description of the Related Art

Modern enterprises engage in many activities wherein information is exchanged by networked computer systems, which efficiently access, transmit, route, receive, and process data to effectively achieve such information exchange. Exchange of information between networked computers allows productive network based interaction and transactions, such as remote access to useful data between a client computer and a server. Useful information technology functions can thus be achieved, including file sharing, web based applications, and a growing host of other convenient and important capabilities.

Organizations that can manage change effectively are generally more successful than those that cannot. Many organizations know that they need to improve their IT-related development processes to successfully manage change. Such organizations typically either spend very little time and/or money on process improvement, because they are unsure how best to proceed; or spend a lot of time and/or money, on a number of parallel and unfocussed efforts, to little or no avail.

### SUMMARY

In accordance with an embodiment of the present disclosure, a system of measuring maturity of an enterprise architecture is provided that includes a health control processor engine that can trigger rebuilding of the heat map topology view and provide recommendations for updating the enterprise architecture towards increased maturity. In one embodiment, the system for measuring performance of an enterprise architecture includes an enterprise collaborative recommender engine that provides recommendations for an account within the enterprise architecture based upon enterprise assessments; a health control process engine that triggers rebuilding of the heat map topology view that provides recommendations for updating the enterprise architecture towards increased maturity in response to recommendations from the enterprise collaborative recommender engine; and an enterprise heat map generator that presents a heat map providing maturity information of the enterprise architecture for each domain. In some embodiments, the enterprise heat map generator includes a display for displaying the enterprise heat map. The display may include a monitor screen that the enterprise heat map is projected onto. In some embodiments, the display may include an interface for the user to select maturity level information from the different domains of the heat map.

In another aspect, the present disclosure provides a method for measuring enterprise maturity. The method may include updating analytics of an account of an enterprise architecture, wherein the update is reported to a health control processing engine; requesting key performance index (KPI) metrics for the enterprise architecture from the health control processing engine; and determining which domain elements can be updated with the key performance indicators (KPI) metrics by the health processing control engine (HCPE). The method for measuring enterprise maturity may further include calculating health metrics, and risk scores for the KPIs with the health processing control engine (HCPE); updating a health assessment of the enterprise architecture with the health processing control engine using the health metric and risk scores; and displaying the health assessment using a heat map. In some embodiments, the display step may include a monitor screen that the enterprise heat map is projected onto. In some embodiments, the display may include an interface for the user to select maturity level information from the different domains of the heat map.

In yet another aspect, a computer program product is provided for measuring enterprise maturity. In one embodiment, the computer program product includes a non-transitory computer readable storage medium having computer readable program code embodied therein for performing a enterprise analysis method. The method may include updating analytics of an account of an enterprise architecture, wherein the update is reported to a health control processing engine; requesting key performance indicator (KPI) metrics for the enterprise architecture from the health control processing engine; and determining which domain elements can be updated with the key performance indicators (KPI) metrics by the health processing control engine (HCPE). The method for measuring enterprise maturity may further include calculating health metrics, and risk scores for the KPIs with the health processing control engine (HCPE); updating a health assessment of the enterprise architecture with the health processing control engine using the health metric and risk scores; and displaying the health assessment using a heat map. In some embodiments, the display step may include a monitor screen that the enterprise heat map is projected onto. In some embodiments, the display may include an interface for the user to select maturity level information from the different domains of the heat map.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram showing an architecture that employs the health control processor engine (HCPE), in accordance with one embodiment of the present disclosure.

FIG. 2 is a block diagram of the model integration and integration of analytics measurements in a KPI-Domain Model Map of the control processor engine (HCPE), in accordance with an embodiment of the present invention.

FIG. 3 is a block diagram of a risk calculator component of the control processor engine (HCPE), in accordance with an embodiment of the present invention.

FIG. 4 is a block diagram illustrating one embodiment of an exemplary processing system employing the health control processing engine (HCPE), in accordance with one embodiment of the present disclosure.

FIG. 5 is a flow diagram of a method for measuring enterprise maturity using a health control processing engine (HCPE), in accordance with one embodiment of the present disclosure.

FIG. 6 is a schematic illustrating one embodiment of some steps of the method for measuring enterprise maturity that is depicted in FIG. 5.

FIG. 7 depicts a cloud computing environment according to an embodiment of the present disclosure.

FIG. 8 depicts abstraction model layers according to an embodiment of the present disclosure.

### DETAILED DESCRIPTION

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

Current definitions of Architecture Capability Maturity Model (ACMM) within the Enterprise Architecture (EA) frameworks do not support statistical methods or ratings based scores to derive an architectural maturity assessment.

Enterprise architecture (EA) is a defined practice for conducting enterprise analysis, design, planning, and implementation, using a comprehensive approach at all times, for the successful development and execution of strategy. Enterprise architecture applies architecture principles and practices to guide organizations through the business, information, process, and technology changes necessary to execute their strategies. These practices utilize the various aspects of an enterprise to identify, motivate, and achieve these changes. Practitioners of enterprise architecture, enterprise architects, are responsible for performing the analysis of business structure and processes and are often called upon to draw conclusions from the information collected to address the goals of enterprise architecture: effectiveness, efficiency, agility, and durability.

A “maturity model” can be viewed as a set of structured levels that describe how well the behaviors, practices and processes of an organization can reliably and sustainably produce required outcomes. A maturity model can be used as a benchmark for comparison and as an aid to understanding—for example, for comparative assessment of different organizations where there is something in common that can be used as a basis for comparison. In the case of the Capability Maturity Model (CMM), for example, the basis for comparison can be the organizations' software development processes.

It has also been determined that it is difficult to gauge or measure an enterprise forte based on its' information technology (IT) environment stability or vulnerability aspects. Information technology is the study or use of systems (especially computers and telecommunications) for storing, retrieving, and sending information.

Additionally, operational analytic tools do not conventionally develop a linkage with the enterprise key performance indicators (KPIs) or cater to measuring enterprise wise maturity indexes. The concept of KPI metrics is a key component in enterprise performance management (EPM) and one that helps management concentrate on how their organization is performing against pre-defined, critical goals and objectives. Finance KPIs may include: days sales outstanding (DSO), return on equity (ROE), working capital, debt to equity ratio, inventory turnover, gross profit margin, net profit margin and combinations thereof.

A “Heat Map” is a type of chart that can be used to visualize data in two dimensions. For example, a heat map may use the color of rectangles to indicate a dimension of the data and the relative size of the rectangles to indicate another dimension. Heat maps can be used to create representations of data for strategic or tactical decision making. Heat maps can be used at any level of a repository from strategic architecture down to Technology architectures. Heat maps can be used to create representations of data for strategic or tactical decision making. Heat maps can be used with requirements to indicate the statuses of a group of requirements and if the metrics are available the estimated implementation cost of each requirement. Heat maps can also be used with an application or technology inventory to show the prevalence of technologies.

It has also been determined that current definitions of Architecture Capability Maturity Model (ACMM) within the Enterprise Architecture frameworks lack a risk-based modelling structure basis of the combination of an account self-assessment feedback and metrics derived from various service management analytics.

The methods, systems and computer programs overcome the above disadvantages using an Enterprise Health Control Processor Engine (HCPE). In some embodiments, the health control processor engine (HCPE) can provide orchestration and business workflows with an insights manager, risk profile evaluator and service delivery insights. In an example workflow, the service delivery insights are providing raw analytical data points, the risk profile evaluator is transforming values from analytics and associated key performance indicators (KPIs) to risk scores, and the insight manager is providing additional insights on underlying issues with respect to the analytics and KPI input values.

This has been currently implemented with the cognitive delivery insights in GTS acting as the data lake which feeds to the HCPE engine and the associated components as risk analyzer scoring engine and forms based evaluation for capturing insights on the issues within an enterprise.

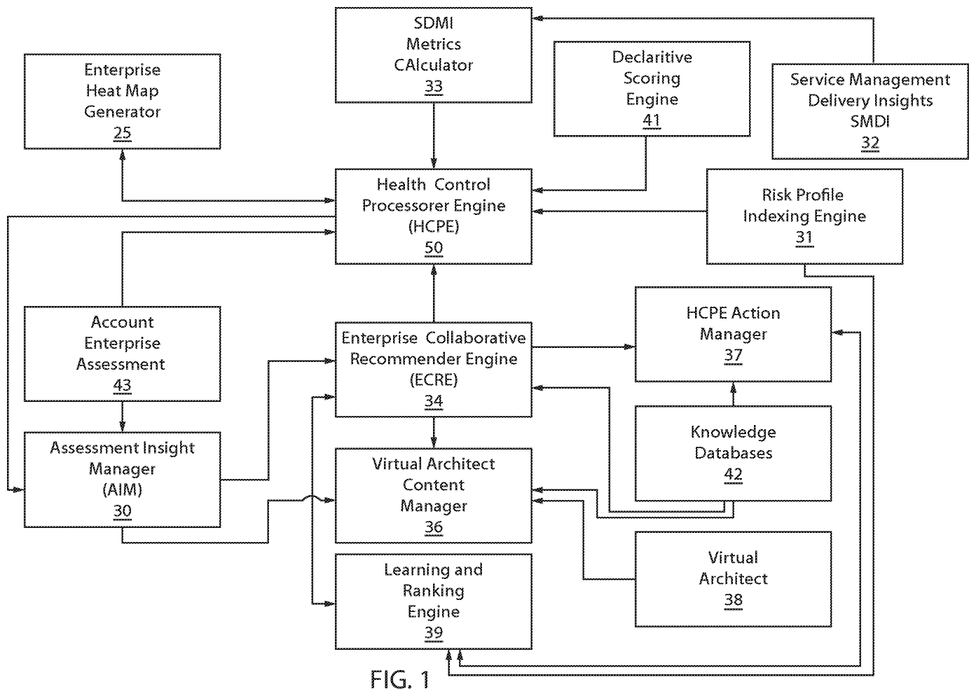

The health control processor engine (HCPE) can amalgamate and process various measurements arising from the service delivery metrics as well as the health control indicators. In some embodiments, the enterprise health control processor engine (HCPE) can trigger certain action events triggered by the basis of certain health control validations, refresh of contents, health-check assessments getting updated, and metrics getting updated. In some embodiments, the action events can be to rebuild the heat map topology view, to re-run the recommendation manager to provide for new recommendations, to provide a new proactive notification for ranking score, to trigger a subscription engine and combinations thereof. The details of the methods, systems and computer program products of the present disclosure are now discussed with greater detail with reference to FIGS. 1-8.

FIG. 1 illustrates one embodiment of the block diagram for an architecture that employs the health control processor engine (HCPE) 50. FIG. 1 illustrates one embodiment of how the health control processor engine (HCPE) is interlinked with the service delivery insights and metrics that are combined with the health controls of goals, indicators, and key performance indicators (KPIs) to create a maturity assessment and risk scores. In some embodiments, the architecture depicted in FIG. 1 provides for dynamic orchestration between the enterprise health control engine, recommender engine, risking indexing module and dynamic heat map generator (HCPOE). In some embodiments, the architecture depicted in FIG. 1 further includes compile risk based vector patterns on the basis of the health controls and service manager delivery insights (SMDI) metrics. The service delivery insights is a data lake encompassing the various data source feeds from various source systems and data aggregated, summarized and presented to the HCPE engine.

In addition to compiling risk-based vector patterns, the systems further provide for the generation of time series analysis of vectors, compares across accounts, compute average vector as a benchmark for industry, build trends in and patterns across accounts with vectors for industry/geo. In regards to the aforementioned comparison across accounts, the HCPE performs a vector comparison of the various risk vectors across accounts. It further computes an average risk vector and then compares the risk vector per account against this average risk vector.

With HCPE capturing risk scores on specific components of Enterprise Architecture maturity model at one point in time, this can also be extended with means of time series analysis. The time series analysis allows for evaluation of trends and patterns in risk score variations. By measuring risk scores of various Enterprise Architecture components in parallel, each risk score of a specific component is transformed as value of a risk vector reflecting the vector dimensionality as body of all measured components. This risk vector can be used as benchmark criterion against specific industries, regions or other filter criteria of the measurement. HCPE analyzes the various trends and patterns from the risk vectors.

In some embodiments, the methods, systems and computer program products that employ the architecture depicted in FIG. 1 can derive an enterprise architecture maturity assessment from component failure impact analysis in a multi-site enterprise IT environment.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring to FIG. 1, the health control processor engine (HCPE) 50 provides for orchestration and business workflows with the insights manager (assessment insight manager (AIM)) 30, risk profile evaluator engine (risk profile indexing engine) 31, and the service delivery insights (service management delivery insights) 32. In some embodiments, the health control processor engine can amalgamate and process various measurements arising from the service delivery metrics as well as the health control indicators. The health control processor engine (HCPE) 50 by computer implemented mechanisms can trigger certain action events. For example, the health control processor engine (HCPE) 50 can trigger certain health control validations, refresh of contents, health-check assessments getting updated, metrics getting updated and combinations thereof. Some of the action events can be used to rebuild the heat-map topology view, re-run the recommendation manager to provide for new recommendations, provide new proactive notifications for ranking scores, and trigger a subscription engine.

As noted above, the health control processor engine (HCPE) 50 provides for orchestration and business workflows in combination with the insights manager (assessment insight manager (AIM)) 30. An “insight” is a thought, fact, combination of facts, data and/or analysis of data that induces meaning and furthers understanding of a situation or issue that has the potential of benefiting the business or re-directing the thinking about that situation or issue which then in turn has the potential of benefiting the business. The insights manager (assessment insight manager (AIM)) 30 can provide key insights, patterns of answers and scores on the various combinations of self-assessment answers provides by the chief architects (CAs), as well as the small and medium enterprise (SME) inputs to the self-assessments. The insights management 30 can provide a systemic view of the issues with business management across all domains and geographies (Geos). The assessment insight manager provides insights of self-assessments to a virtual architect content manager 36.

Referring to FIG. 1, the health control processor engine (HCPE) 50 provides for orchestration and business workflows in combination with the risk profile evaluator engine (risk profile indexing engine) 31. The risk profile evaluator engine 31 calculates the risk scores. Risk can by evaluated by both the likelihood that a risk event will occur and the impact of the risk event if it does occur. The actual ranking of risks can be determined by either calculating the product of likelihood×impact scores, or in some cases the sum of a risk's likelihood and impact scores. When using this methodology, the risk profile evaluator engine 31 develops rating scales for both likelihood and impact (and any other dimensions to be assessed, such as velocity or preparedness) as well as definitions for each point on the scales. Risk scores calculated by the risk profile evaluator engine 31 can provide the basis for the outcome of the maturity assessment provided by the metrics calculated through applying a set of parameterized goals and common metrics. In some embodiments, the risk profile evaluator engine 31 can also provide risk patterns mapping back to the health control processor self-assessment queries. In this example, the risk pattern maps will obtain feedback from the health control processor engine (HCPE) 50 self-assessment queries. In some embodiments, the risk profile evaluator engine 31 can build and compile risk-based vector patterns and is able to generate time series analysis of vectors, compare across accounts, computer average vectors as a benchmark for industry standard, and can check for trends and patterns in and across accounts with vectors for each industry and/or geographic location.

Referring to FIG. 1, the health control processor engine (HCPE) 50 provides for orchestration and business workflows in combination with the service delivery insights (service management delivery insights) 32. In one embodiment, the service management delivery insights block identified by reference number 32 is an insights analytic engine that includes server configuration data, operation and management data, which when combined with statistical, and text analysis provides insights to drive costs savings and revenue opportunities. The management data may include tickets, alerts and compliance notices. One example of a revenue opportunity may be through contract renewals. Another example of a revenue opportunity may be through a new logo deal. The service management delivery insight (SMDI) provides service delivery metrics to the SMDI metrics calculator 33.

In some embodiments, the architecture depicted in FIG. 1 provides for dynamic orchestration between the enterprise health control engine 50, recommender engine 34, risking indexing module 31 and dynamic heat map generator (HCPOE) 75. In some embodiments, the recommender engine 34 provides cognitive recommendations to the health control processor engine 50 for an account based upon the health-controls, self-assessments and Service delivery metrics generated. In some embodiments, the recommender engine 34 would use the cognitive solution to interpret a user entered “description” of the issue (i.e., the observation), identify associated keywords (not necessarily keywords found in the description, but those associated with the understanding of the issue) for the basis of the inputs to the Health control processor.

In some embodiments, the dynamic heat map generator (HCPOE) 75, also referred to as the Enterprise Heat Map generator, provides a dynamic, heat map having selectable regions that can be activated by graphic user interface (GUI) present on a computer screen displayed from a computer, which allows a user to examine the maturity scores at each level and domain. In some embodiments, the dynamic heat map generator (HCPOE) 75 provides references to assessments done on account technology plan, technical risk mitigation, client relationship, technical governance, and operational stability, etc. The enterprise heat map generator provides domain packages.

In some embodiments, the dynamic heat map generator (HCPOE) 75 includes a display for displaying the enterprise heat map. The display may include a monitor screen that the enterprise heat map is projected onto. The monitor screen may include a computer screen, a touch screen, a light emitting diode (LED) screen, a LCD screen, and combinations thereof. In some embodiments, the display may include an interface for the user to select maturity level information from the different domains of the heat map. In some embodiments, the dynamic heat map generator (HCPOE) 75 includes a projector for projecting an image including the enterprise heat map.

In some embodiments, the enterprise maturity assessment components of the architecture including the Health Control Processor Engine (HCPE) that is depicted in FIG. 1 can also include a Health Control Processor Engine (HCPE) action manager 37. The HCPE action manager 37 can handle all the action managements, and post inputs from the observation recommendation repository (ORR) and recommender engine, i.e., Enterprise Collaborative Recommender Engine (ECRCE) 34), in terms of interacting with dynamic automation to trigger actions on the basis of work flow rules engine; maintaining status, checking success criteria of actions, providing with multiple and alternative, parallel courses of actions, value tracking, success/failure dashboards, and combinations thereof. The Observation Recommendation Repository (ORR) is the knowledge-base that the Health Control Processor Engine (HCPE) refers to.

For example, the enterprise collaborative recommender engine (ECRCE) 34 provides action to the HCPE action manager 37.

In some embodiments, the enterprise maturity assessment components of the architecture including the Health Control Processor Engine (HCPE) that is depicted in FIG. 1 can also include a service management delivery insights (SMDI) metrics calculator 33. The SDMI metrics calculator 33 can parametrize various goals, performs various computes on the metrics from SMDI based on business rules, performs KPI aggregations, and can provide positive/lag indicators. The SDMI metrics calculator 33 can also map goals to metrics and KPIs. In some embodiments, the SDMI 65 provides service deliver metrics to the SDMI metrics calculator 33, in which the SDMI metrics calculator 33 is an input to the health control processor engine (HCPE) 50.

In some embodiments, the enterprise maturity assessment components of the architecture including the Health Control Processor Engine (HCPE) that is depicted in FIG. 1 can also include a virtual architect (VA) 38. The virtual architect (VA) 38 provides a self-service capability for consumers, e.g., chief architects of the enterprise, who should be able to interact with the multiple knowledge bases and global best practices. In some embodiments, the virtual architect (VA) 38 simplifies the discovery of applicable assets when issues or degraded services on the IT environment are detected, and to provide an automated clustering of best recommendations how to resolve these issues.

Still referring to FIG. 1, the learning and ranking engine 39 may be a cognitive continuous learning engine that functions with the declarative scoring engine 41. The bi-directional arrow between the learning and ranking engine 39 and the declarative scoring engine 41 illustrates the machine learning life cycle on the declarative scoring engine 41.

In some embodiments, the learning and ranking engine 39 performs machine level statistics and rolls up higher to build up maturity assessment ranking scores basis of various metrics calculations. The bi-directional arrows depicted in FIG. 1 reflect the machine learning cycle with one direction representing the feedback on current values, and the reverse direction feeding back an update to the machine learning model. The learning and ranking engine 39 can also feed to the risk profile evaluator 31 to derive risk-based scores. As the learning and ranking engine 39 is a component which will provide feedback based learning to all the related components within the HCPE, all of the arrows to the component 39 are bi-directional.

In some embodiments, the enterprise maturity assessment components of the architecture including the Health Control Processor Engine (HCPE) that is depicted in FIG. 1 can also include declarative scoring engine (DSE) 41. In one example, the declarative scoring engine (DSE) 41 contains pre-existing rule-sets for various computations of metrics, health-assessment scores, heat-map rules, recommendation choices, risk evaluation criteria, and combinations thereof. Declarative scoring rules are configuration instances of the declarative scoring engine (DSE) 41.

Referring to FIG. 1, the virtual architect content manager 36 is responsible for annotating, ingesting and managing different data-sources emanating from multiple data-sources and knowledge databases, account self-assessment repository and provide a single query interface with standard adapter to all the knowledge databases. The enterprise architecture may also include a knowledge database 42 that can provide best practices to the enterprise collaborative recommender engine 34. The account enterprise assessment 33 provides health control, goals, enablers and indicators to the health control processor engine 50.

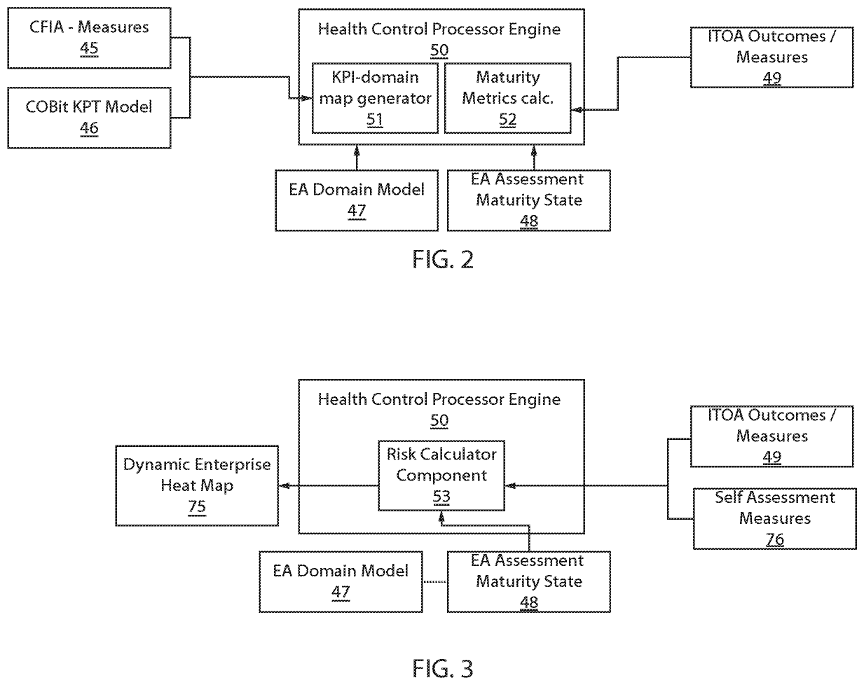

FIG. 2 is a block diagram of the health control processor engine (HCPE) 50 illustrating a KPI-Domain Map generator 51. The KPI-Domain Model Map provides a key performance indicators (KPI) mapping table between key performance indicators (KPI) from Component Failure Impact Analysis (CFIA) 45, KPIs from industry process models, e.g., CoBIT 46, and Enterprise Architecture (EA) domain model 47. In some embodiments, the KPI-Domain Model Map provides a static mapping from a “measure” (a KPI metric in my UML model), that originates from an industry standard model, to an element in the EA Domain Model, and vice versa. Examples of industry process models include component failure impact analysis (CFIA) risk assessment model, Control Objectives for Information and Related Technologies (CoBit) and ITIL. COBIT (Control Objectives for Information and Related Technologies) is a good-practice framework created by international professional association ISACA for information technology (IT) management and IT governance. In one example, CoBit provides an implementable “set of controls over information technology and organizes them around a logical framework of IT-related processes and enablers.” ITIL (formerly an acronym for Information Technology Infrastructure Library) is a set of detailed practices for IT service management (ITSM) that focuses on aligning IT services with the needs of business. In one example, the ITIL describes processes, procedures, tasks, and checklists which are not organization-specific or technology-specific, but can be applied by an organization for establishing integration with the organization's strategy, delivering value, and maintaining a minimum level of competency. The ITIL can allow an organization to establish a baseline from which it can plan, implement, and measure. The ITIL can allow an organization to demonstrate compliance and to measure improvement.

Still referring to FIG. 2, the enterprise architecture domain model 125 is a broad view of an enterprise or system. It is a partial representation of a whole system that addresses several concerns of several stakeholders. It is a description that hides other views or facets of the system described. In some embodiments, there can be four types of architecture domain, such as the business architecture, the data architecture, the applications architecture and the technology architecture.

In an example of a business architecture of an enterprise architecture domain model 47, the structure and behavior of a business system (not necessarily related to computers) covers business goals, business functions or capabilities, business processes and roles etc. Business functions and business processes are often mapped to the applications and data they need.

In an example of a data architecture of an enterprise architecture domain model 47, the data structures used by a business and/or its applications includes descriptions of data in storage and data in motion. Descriptions of data stores, data groups and data items may be included in the data architecture, as well as mappings of those data artifacts to data qualities, applications, locations etc.

In an example of an applications architecture of an enterprise architecture domain model 47, the applications architecture may detail the structure and behavior of applications used in a business, focused on how they interact with each other and with users. The applications architecture may be focused on the data consumed and produced by applications rather than their internal structure. In application portfolio management, the applications are usually mapped to business functions and to application platform technologies.

In an example of a technology architecture/technical architecture or infrastructure architecture of an enterprise architecture domain model 47, the Technology architecture/Technical architecture or infrastructure architecture covers the client and server nodes of the hardware configuration, the infrastructure applications that run on them, the infrastructure services they offer to applications, the protocols and networks that connect applications and nodes.

Referring to FIG. 2, the KPI-domain map generator 51 associates measures from the different industry models (e.g. CFIA, CoBit, ITIL) to components from Enterprise Architecture (EA) frameworks, e.g. TOGAF. The Open Group Architecture Framework (TOGAF) is a framework for enterprise architecture that provides an approach for designing, planning, implementing, and governing an enterprise information technology architecture. TOGAF is typically modeled at four levels: Business, Application, Data, and Technology. The model integration is implemented as mapping table of combined CFIA indicators and KPI models with a linkage to component classes in the EA domain model.

FIG. 2 is a block diagram of the health control processor engine (HCPE) 50 that also illustrates a maturity metrics calculator 52 that provides a mapping of measures associated with the outcome of IT operational analytics tools and insights 49. The maturity metrics calculator 52 provides a rules based calculation of the health state (maturity score) 48 for components/elements in the enterprise architecture (EA) Domain Model 47 for a set of KPI metrics. One example of a rules-based calculation that can provide a heat state, i.e., maturity score, for the components/elements of the enterprise architecture (EA) that can be provided by the maturity metrics calculator 52 the maturity of the change management process based on the ratio of the number of emergency changes against all changes in a given timeframe. An example of the Rules based calculation within the Declarative Scoring Engine component is that on the basis of the maturity score and the associated rules, it can capture a change of the state of the heat map for the components within the Enterprise Architecture.

In one embodiment, the maturity metrics calculator 52 provides an integration of IT operational analytics (ITOA) tools and their outcomes with the health state (maturity score) of components of the EA domain model. IT operations analytics (ITOA) (also known as advanced operational analytics, or IT data analytics) technologies are primarily used to discover complex patterns in high volumes of often “noisy” IT system availability and performance data. IT analytics can use of mathematical algorithms to extract meaningful information from the sea of raw data collected by management and monitoring technologies. In some embodiments, artificially intelligent operational analytics platforms engage in the high-level pattern recognition that could adequately serve business needs.

Five applications of ITOA systems that can be used with the maturity metrics calculator 52 include root cause analysis, proactive control of service performance and availability, problem assignment, service impact analysis, complement of Best-of breed technology, Real time application behavior learning, Dynamically Baselines Threshold and combinations thereof.

Root Cause Analysis refers to the use of models, structures and pattern descriptions of IT infrastructure or application stack being monitored can help users pinpoint fine-grained and previously unknown root causes of overall system behavior pathologies. Proactive Control of Service Performance and Availability predicts future system states and the impact of those states on performance. Problem Assignment can determine how problems may be resolved or, at least, direct the results of inferences to the most appropriate individuals or communities in the enterprise for problem resolution. Service Impact Analysis can be employed when multiple root causes are known, the analytics system's output is used to determine and rank the relative impact, so that resources can be devoted to correcting the fault in the most timely and cost-effective way possible. Complement Best-of-breed Technology uses the models, structures and pattern descriptions of IT infrastructure or application stack being monitored to correct or extend the outputs of other discovery-oriented tools to improve the fidelity of information used in operational tasks (e.g., service dependency maps, application runtime architecture topologies, network topologies). Real time application behavior learning can learn & correlate the behavior of an application based on user pattern and underlying Infrastructure on various application patterns, create metrics of such correlated patterns and store it for further analysis. Dynamically Baselines Threshold can learn behavior of Infrastructure on various application user patterns and determines the Optimal behavior of the Infra and technological components, bench marks and baselines the low and high-water mark for the specific environments and can dynamically change the bench mark baselines with the changing infra and user patterns without any manual intervention.

Five types of analytics technologies for the ITOA systems that can be used with the maturity metrics calculator 52 can include log analysis, unstructured text indexing, search and inference (UTISI), topological analysis (TA), multidimensional database search and analysis (MDSA), complex operations event processing (COEP), statistical pattern discovery and recognition (SPDR) and combinations thereof.

The integration of the IT operational analytics and their outcome 49 with the health control processor engine 50 is implemented by the maturity metrics calculator 52 as a configuration parameter table describing the influence (transformation parameter) of component's health condition and state from the enterprise architect (EA) domain model 47 to the assessment scores 48. Hereby, the analytics tools outcome, i.e., outcome of the maturity metrics calculator 52, is calculated as assessment health state/score change of components of the EA domain model.

FIG. 3 depicts one embodiment of a risk calculator component 53 of the health control processor engine (HCPE) 50. In some embodiments, the risk calculator component 53 of the health control processor engine (HCPE) 50 provides a transformation matrix between ongoing measures from IT operational analytics 49 combined with self-assessment outcomes and current Enterprise Architecture (EA) assessment maturity state 48. The risk calculator component 53 of the health control processor engine (HCPE) 50 provides a rules-based calculation of the risk for components/elements in the Enterprise Architecture (EA) Domain Model 47 for a set of key performance indicator (KPI) metrics. One example of a rules-based calculation of the risk for components/elements in the Enterprise Architecture (EA) Domain Model for a set of KPI metric can include the weighted average value of ‘Mean Time to Repair (MTTR)’ and ratio of severity 1 incidents, transformed to an incident management risk score of a specific environment component. The transformation of the input values to the risk score is calculated in support of a configured transformation graph with the boundaries of lowest and best practice performance values.

Referring to FIG. 3, in some embodiments, the risk calculator component 53 of the health control processor engine (HCPE) 50 provides a Dynamic Operational Risk Score Evaluation. The risk calculator component 53 of the health control processor engine (HCPE) 50 provides a transformation matrix and data lineage between IT operational analytics 49, self-assessment outcomes (also referred to as self-assessment measures 76) and IT operational risk scores. IT Operational Risk can be calculated by the Risk Calculator Component (53).

The transformation matrix is implemented as mapping table of measures from ITOA (e.g. Incident resolution rate) to a scale of maturity assessment scores used to represent the enterprise architecture (EA) assessment maturity state. In one embodiment, the scale may range from 1 to 5, in which a value of 5 at the maximum value of the scale represents best practice, i.e., high maturity, and a value of 1 at the minimum of the sale represents poor maturity. The deviation between newly calculated maturity assessment score and previous EA assessment maturity state is transformed to a scale between 0% and 100% of operational risk. For the risk evaluation weighting parameters and a transformation function/graph is used to provide a prescriptive method of operational risk evaluation.

The result of operational risk evaluation is then presented in a dynamic enterprise heat map 75. The enterprise heat map 75 is a representation of a dynamic, clickable heat map, which allows the user to examine the maturity scores at each level and domain. It provides references to assessments done on account technology plan, technical risk mitigation, client relationship, technical governance, operational stability, etc. In some embodiments, the enterprise heat map 75 attributes provide a data lineage back to the raw data of measures from IT operational analytics to follow up with the causality of maturity state changes.

In some embodiments, the enterprise heat map 75 is displayed on a monitor screen that the enterprise heat map is projected onto. The monitor screen may include a computer screen, a touch screen, a light emitting diode (LED) screen, a LCD screen, and combinations thereof. In some embodiments, the display may include an interface for the user to select maturity level information from the different domains of the heat map. In some embodiments, the enterprise heat map 75 is projected by a projector for projecting an image to be viewed by the user.

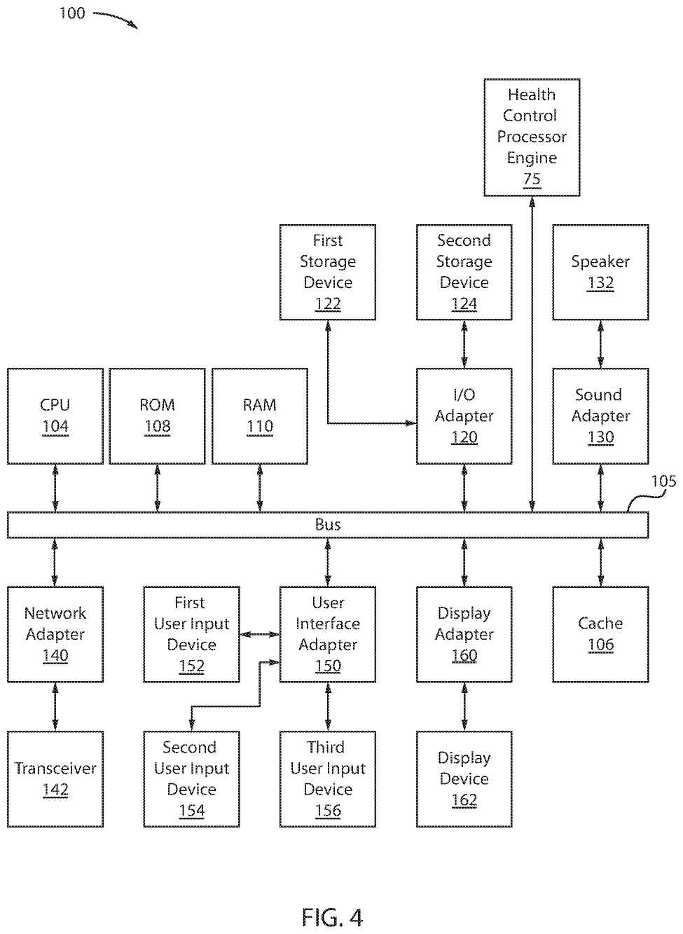

FIG. 4 illustrates one embodiment of an exemplary processing system 100 in which the health control processing engine (HCPE) of the present disclosure, as described with reference to FIGS. 1-3, may be applied. The processing system 100 includes at least one processor (CPU) 104 operatively coupled to other components via a system bus 102. A cache 106, a Read Only Memory (ROM) 108, a Random-Access Memory (RAM) 110, an input/output (I/O) adapter 120, a sound adapter 130, a network adapter 140, a user interface adapter 150, and a display adapter 160, are operatively coupled to the system bus 105.

The health control processor engine 50, as described with reference to FIGS. 2 and 3, may be incorporated into the processing system 100 that is depicted in FIG. 4, via connectivity of the health control processor engine 40 with the system bus 105.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

The methods of the present disclosure may be computer implemented methods that can employ a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

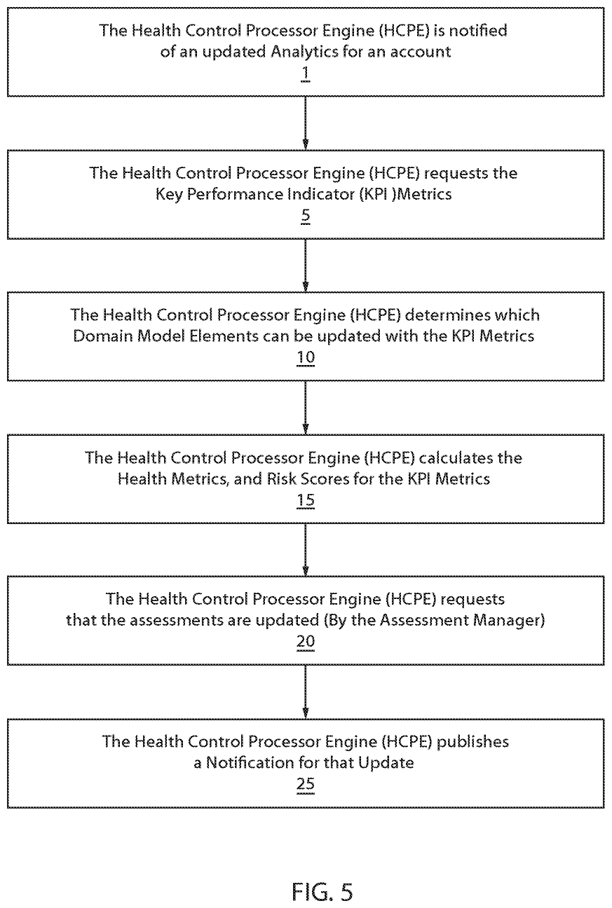

FIG. 5 is a flow diagram of one embodiment of a method for measuring enterprise maturity using a health control processing engine 50, as described with reference to FIGS. 1-4. In one embodiment, the method may be with block 1, which includes the health control processing engine 50 being notified of updated analytics for an account. The input sources to HCPE component 50 are health controls based on service manager delivery insights (SMDI) metrics 32, 33 and/or account enterprise assessment component 43. A changed state on either of those input sources will notify HCPE (50) of updated input data thus kicking off the data flow starting with block 1.

At block 5, the method may continue with a request form the health control processing engine for the key performance index (KPI) metrics. The KPI metrics may be provided by the Maturity Metrics calculator 52.

Referring to block 10, in a following process step, the method may continue with the health processing control engine (HCPE) 50 determining which domain elements can be updated with the key performance indicators (KPI) metrics.

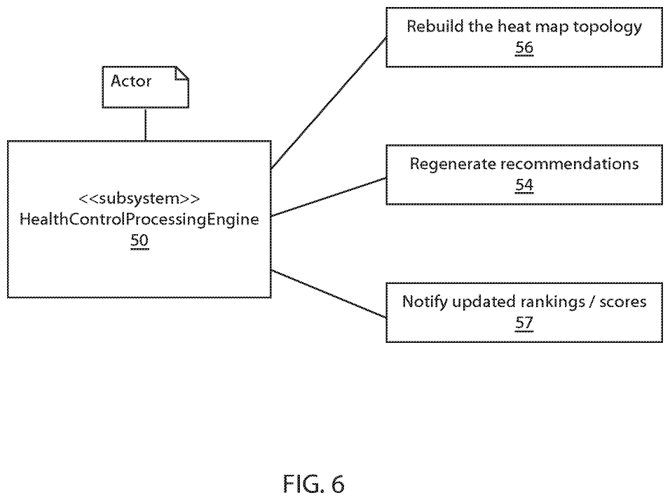

Still referring to FIG. 5, at block 15, in some embodiments, after determining which domain elements can be updated, the health processing control engine (HCPE) 50 calculates the Health Metrics, and Risk scores for those KPIs, e.g., the KPI's employed at block 10. FIG. 6 illustrates the regenerating recommendation step with reference number 54.

Referring to block 20 of FIG. 5, the health processing control engine (HCPE) 50 requests that the assessments are updated. For example, the assessments may be updated by the Assessment Insight Manager 30. The updated assessments may be published using a heat map using the enterprise heat map generator 75. FIG. 6 illustrates rebuilding the heat map topology with reference number 56.

The health processing control engine (HCPE) 50 publishes a notification for the update at block 25. FIG. 6 illustrates the health processing control engine (HCPE) 50 providing a notification of updated rankings/stores 57.

It is understood that this disclosure includes a detailed description on cloud computing, implementation of the teachings recited herein are not limited to a cloud computing environment. Rather, embodiments of the present invention are capable of being implemented in conjunction with any other type of computing environment now known or later developed.

The methods of the present disclosure may be practiced using a cloud computing environment. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

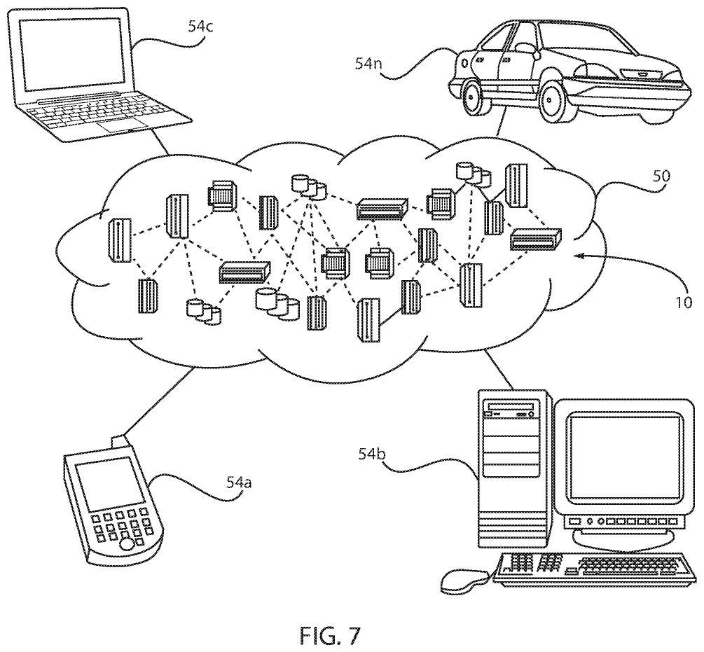

Referring now to FIG. 7, illustrative cloud computing environment 50 is depicted. As shown, cloud computing environment 50 includes one or more cloud computing nodes 51 with which local computing devices used by cloud consumers, such as, for example, mobile and/or wearable electronic devices 100, desktop computer 54B, laptop computer 54C, and/or automobile computer system 54N may communicate. Nodes 110 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 51 and cloud computing environment 50 can communicate with any type of computerized device over any type of network and/or network addressable connection (e.g., using a web browser).

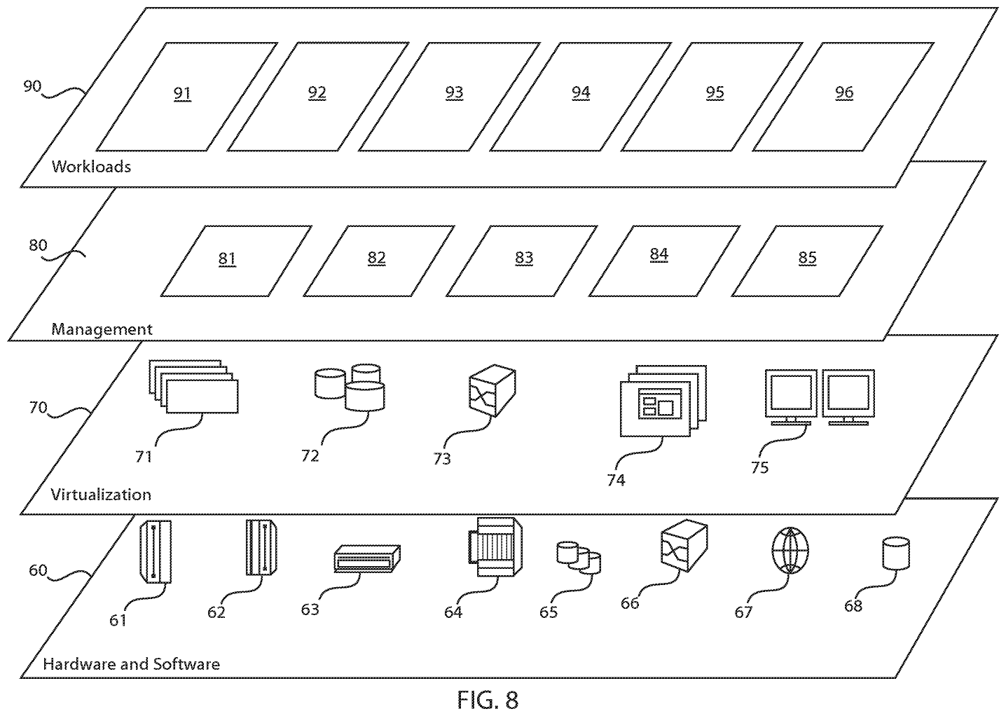

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and health control processing engine 50, which is described with reference to FIGS. 1-6.

In some embodiments, the methods, systems and computer program products of the present disclosure can dynamically orchestrate between enterprise health-control engine 50, recommender engine, risk indexing module, and the dynamic heat map generator (HCPOE) 75.

In some embodiments, the methods, systems and computer program products of the present disclosure provide risk based modelling based upon the combination of an account self-assessment feedback, insights and metrics derived from various service management analytics.

In some embodiments, the methods, systems and computer program products of the present disclosure provide dynamically generated enterprise heatmaps to provide assessments with domain wise status across the entire enterprise in reference to account technology plans, technical risk mitigation, client relationship, technical governance, operational stability, and combinations thereof. For instance, a degraded domain status of server patch management may provide assessment details and recommendations, and priority tasks for the future technology plan. Additional risk scores detected on security related domains may require technical risk mitigation according to defined security policies. Likewise with degraded domain status on operational processes such as incident management, may trigger adjusted priorities of severity 1 incidents based on specific assessments and metrics. All those assessments and domain wise status contribute to improved operational stability and/or governance disciplines. In some embodiments, the methods, systems and computer program products of the present disclosure compile risk based vector patterns on the basis of health controls and SMDI metrics, generate time series analysis of vectors, compare across accounts, compute average vector as a benchmark for industry, and Build trends in and patterns across accounts with vectors for industry/geographies.

In some embodiments, the methods, systems and computer program products of the present disclosure derive Enterprise Architecture Maturity assessments from component failure impact analysis in a multi-site Enterprise IT environment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A system for measuring performance of an enterprise architecture comprising:
an enterprise collaborative recommender engine that provides recommendations for an account within an enterprise architecture based upon enterprise assessments;
a health control process engine that triggers building of a heat map topology view for updating the enterprise architecture towards increased maturity in response to recommendations from the enterprise collaborative recommender engine; and
an enterprise heat map generator that in response to the heap map topology built by the health control process engine, presents a heat map providing maturity information of the enterprise architecture for each domain.

2. The system of claim 1, wherein enterprise assessments are selected from the group consisting of health controls, self-assessments, service delivery metrics and combinations thereof.

3. The system of claim 1, wherein an insights manager provides insights on the enterprise architecture to the health control processor engine, in which the health control processor engine employs the insights for rebuilding the heat map topology.

4. The system of claim 3, wherein a risk profile evaluator editor builds risk based vector patterns on the insights that the health control processor engine employs to trigger the building of heat map topologies.

5. The system of claim 1, wherein a health control processing engine (HCPE) action manager works with the enterprise collaborative recommender engine to trigger actions by the health control processor engine (HCPE), wherein the trigger action managed by the HCPE action manager are selected from the group consisting of work flow rules, status updates, checking success criteria of actions, value tracking, success/failure dashboards and combinations thereof.

6. The system of claim 1, wherein the health control processing engine (HCPE) comprises a key performance indicator (KPI)-domain map generator, maturity metrics calculator and risk calculator.

7. The system of claim 6, wherein the key performance indicator (KPI)-domain map generator includes a component failure impact analysis (CFIA), key performance indicators from industry process models and an enterprise architecture (EA) domain model.

8. The system of claim 7, wherein the maturity metric calculator comprises an integration of IT operation analytics (ITOA) and an enterprise architecture (EA) assessment maturity state into the health control processor engine (HCPE).

9. The system of claim 8, wherein the risk calculator provides a data lineage between IT operational analytics, self-assessment measures and IT operational risk scores.

10. A method for measuring enterprise maturity comprising:
updating analytics of an account of an enterprise architecture, wherein the update is reported to a health control processing engine;
requesting key performance index (KPI) metrics for the enterprise architecture from the health control processing engine;
determining which domain elements can be updated with the key performance indicators (KPI) metrics by the health processing control engine (HCPE);
calculating health metrics, and risk scores for the KPIs with the health processing control engine (HCPE);
updating a health assessment of the enterprise architecture with the health processing control engine using the health metric and risk scores; and
displaying the health assessment using a heat map.

11. The method of claim 10, further comprising providing a notification to users of the enterprise architecture of updated rankings/stores.

12. The method of claim 10, further comprising an enterprise collaborative recommender engine that provides recommendations to the health control process engine for an account within the enterprise architecture based upon enterprise assessments.

13. The method of claim 12, further comprising an enterprise heat map generator that in response to a heat map topology build by the health control process engine presents a heat map providing maturity information of the enterprise architecture for each domain.

14. The method of claim 10, wherein the health control processing engine (HCPE) comprises a key performance indicator (KPI)-domain map generator, maturity metrics calculator and risk calculator.

15. The method of claim 14, wherein the key performance indicator (KPI)-domain map generator includes a component failure impact analysis (CFIA), key performance indicators from industry process models and an enterprise architecture (EA) domain model.

16. The system of claim 15, wherein the maturity metric calculator comprises an integration of IT operation analytics (ITOA) and an enterprise architecture (EA) assessment maturity state into the health control processor engine (HCPE).

17. The method of claim 16, wherein the risk calculator provides a data lineage between IT operational analytics, self-assessment measures and IT operational risk scores.

18. A computer program product comprising a non-transitory computer readable storage medium having computer readable program code embodied therein for performing a security method, the security method comprising:
updating analytics of an account of an enterprise architecture, wherein the update is reported to a health control processing engine;
requesting key performance index (KPI) metrics for the enterprise architecture from the health control processing engine;
determining which domain elements can be updated with the key performance indicators (KPI) metrics by the health processing control engine (HCPE);
calculating health metrics, and risk scores for the KPIs with the health processing control engine (HCPE);
updating a health assessment of the enterprise architecture with the health processing control engine using the health metric and risk scores; and
displaying the health assessment using a heat map.

19. The computer program product of claim 18, wherein the method further comprises providing a notification to users of the enterprise architecture of updated rankings/stores.

20. The computer program product of claim 18, wherein the method further comprises an enterprise collaborative recommender engine that provides recommendations to the health control process engine for an account within the enterprise architecture based upon enterprise assessments.
